(19) United States
(12) Patent Application Publication
(10) Pub. No.: US 2004/0130704 A1
(43) Pub. Date: Jul. 8, 2004

(54) Optical property determination using differences in signal responses to applied modulated laser signals

(76) Inventors: Josef Beller, Tuebingen (DE); Joachim Peerlings, Ehningen (DE)

Correspondence Address: PERMAN & GREEN, 425 POST ROAD, FAIRFIELD, CT, 06824, US

(21) Appl. No.: 10/467,694

(22) PCT Filed: Apr. 4, 2002
(86) PCT No.: PCT/EP02/03722

(30) Foreign Application Priority Data
Apr. 5, 2001 (EP) 01108644.4

(51) Int. Cl. G01N 21/00

(52) U.S. Cl. 356/73.1

(57) ABSTRACT

A characteristic of an optical property of a device under test—DUT—is determined by providing to the DUT a first laser signal at a first center wavelength, modulated by a first modulation frequency, and a second laser signal at a second center wavelength, modulated by a second modulation frequency. Response signals from the DUT on the applied first and second laser signals are received. The characteristic of the optical property of the DUT is then determined based on an analysis of the received response signals for different measurement setups of parameter settings for the first center wavelength, the first modulation frequency, the second center wavelength, and the second modulation frequency, in conjunction with the parameter settings for each measurement setup.

### BACKGROUND OF THE INVENTION

The present invention relates to the measurement of optical properties such as chromatic dispersion.

A standard way for measuring chromatic dispersion (CD) is the so-called modulation phase-shift method as described e.g. on pages 482ff in ‘Fiber Optic Test and Measurement’ by Dennis Derickson, ISBN 0-13-534330-5, 1998. This method, however, is not suitable for in situ measurements of fiber paths.

### SUMMARY OF THE INVENTION

It is an object of the invention to provide an improved measurement of an optical property of an optical device under test, such as chromatic dispersion. The object is solved by the independent claims. Preferred embodiments are shown by the dependent claims.

According to the present invention, the characteristic of an optical property (preferably chromatic dispersion CD or group delay GD) of a device under test (DUT) is determined by applying a first and a second laser signal to the DUT. The first laser signal is provided at a first center wavelength and intensity modulated by a first modulation frequency. The second laser signal is provided at a second center wavelength and intensity modulated by a second modulation frequency. Response signals from the DUT on the applied first and second laser signals are received by a receiving unit and further provided to a processing unit for determining therefrom the characteristic of the optical property of the DUT.

Whereas the aforementioned modulation phase-shift method requires to provide both the reference signal applied to the stimulus signal and the response signal of the DUT on the stimulus signal, the invention avoids this necessity to provide the reference signal for evaluation. Instead, the invention determines the characteristic of the DUT optical property from differences in response signals on different applied stimulus signals. The invention thus does not require an additional reference transmission path for supplying the reference signal for evaluation. This is in particular of advantage in fiber path systems (e.g. over hundreds of kilometers length), where otherwise such additional reference transmission path would have been necessary. Thus, ‘in-situ’ measurements even over long distances and without requiring such additional paths solely for measuring purposes are rendered possible.

In operation, for determining the characteristic of the optical property of the DUT, at least one of the parameters, first center wavelength, first modulation frequency, second center wavelength, or second modulation frequency, is varied. For each variation, the processing unit determines a value of the optical property of the DUT based on differences in signal phases of the response signals.

In case the modulation frequency is equal for the first and second laser signals, differences in the center wavelengths lead to phase differences between the response signals on the first and second laser signals. E.g. CD or GD can then be determined from those phase differences. Lower modulation frequencies can be applied for reducing ambiguities in the interpretation of the phase differences, while higher modulation frequencies can be applied for increasing resolution. A variation in the modulation frequency, however equal for both laser signals, can thus improve accuracy of the measurement results.

The first and second laser signals can be applied concurrently or sequentially, and that the response signals on the first and second laser signals can thus be detected either in common (as superimposed signals) or as individual signals. In the former case, the phase differences have to be derived from the superimposed response signals, and signal separation might be provided to derive the individual response signals from the superimposed response signals. In the latter case, the first and second laser signals can be e.g. temporally displaced (e.g. one is switched on while the other is switched off), and a phase jump between the two response signals will be detected. Alternatively, the phase of the switched off or displaced response signal is maintained as reference phase for evaluating the differences in signal phases of the response signals. This can be done e.g. by emulating, sampling, synthesizing, or otherwise generating the reference phase while the actual response signal is still on and maintaining this generated reference phase at least until a next response signal on a next applied laser signal appears (and can be sufficiently detected for the phase comparison). One preferred way to generate the reference phase is by synchronizing a reference oscillator e.g. using Phase Locked Loop (PLL) circuits.

For determining chromatic dispersion (CD) or group delay (GD) as optical property of the DUT, the processing unit preferably applies the principles of the aforementioned modulation phase-shift method for evaluating the differences in signal phases of the response signals. The teaching of the aforementioned book by Dennis Derickson with respect to evaluating differences in signal phases of response signals according to the modulation phase-shift method shall be incorporated herein by reference. However other known algorithms and methods for evaluating signal phase differences can be applied accordingly.

In order to evaluate the response signals, the processing unit needs to know for each measurement the present settings (e.g. the values) of the parameters: first center wavelength, first modulation frequency, second center wavelength, and second modulation frequency. Using that knowledge or information of the present parameter settings together with the determined response signal for the parameter settings allows the processing unit to determine the characteristic of the optical property of the DUT by comparing with the determined response signal for different parameter settings.

In one embodiment, the processing unit receives the current parameter settings applied for the generation of the first and second laser signals, e.g. from the laser source(s) for generating the first and second laser signals or a control unit therefore. This can be done wired or wireless, whereby it will be appreciated that standard electronic communication paths will generally be sufficient for the transmission of the present parameter settings. It is also possible to modulate the laser signals with the encoded measurement parameters and transmit this information through the DUT to a receiver of the processing unit.

In another embodiment, the processing unit already has knowledge of the present parameter settings. This can be accomplished by following predefined measurement protocols with a defined sequence in a variation of the parameter settings. Start procedures for initiating and synchronizing a defined measurement protocol, both for the signal generation and signal evaluation, can be applied as well known in the art.

In another embodiment, the processing unit will determine the present parameter settings. This can be accomplished by providing adequate measuring sensors or devices (e.g. for measuring wavelengths and/or modulation frequencies) with the processing unit.

It goes without saying that the invention is not limited to only two different laser signals but that a plurality of different laser signals can be applied in accordance with the above said. Thus, the optical property/properties can be determined with higher accuracy and/or over a wider range.

It is clear that the invention can be partly or entirely embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawing.

FIG. 1 shows a preferred embodiment of a chromatic dispersion test setup according to the present invention.

### DETAILED DESCRIPTION OF THE INVENTION

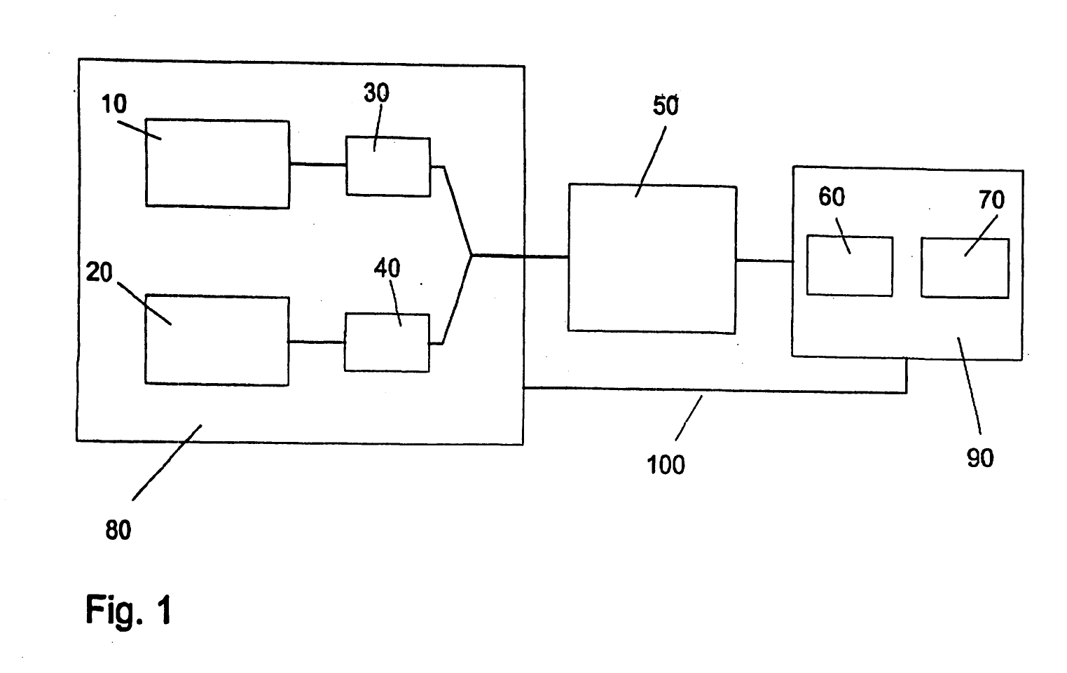

In FIG. 1, two laser sources 10 and 20, e.g. fixed or tunable in wavelength, are each externally modulated by modulators 30 and 40, and provide a stimulus signal to a device under test (DUT) 50. A receiver 60 receives response signals on the stimulus signals from the DUT 50 and provides those to a processing unit 70.

The two laser sources 10 and 20 together with the modulators 30 and 40 belong to a signal generation unit 80, while the receiver 60 together with the processing unit 70 belong to a signal evaluation unit 90. Communication between the signal generation unit 80 and the signal evaluation unit 90 might be provided by a link 100, which can be a wired or wireless link e.g. through a data network. It is to be understood that the type of the link 100 can depend on the specific application, in particular on the type of DUT 50. In case of a fiber path over long(er) distances as DUT 50, the link 100 might be a LAN connection or a wireless connection as known in the art.

In operation, the two laser sources 10 and 20 are set to different wavelengths and are modulated with frequencies preferably between 1 and 10 GHz. The receiver 60 measures the signal responses of the DUT 50 on the two applied laser signals. The chromatic dispersion of the DUT 50 is determined from the different signal phases. Preferably, the aforementioned known modulation phase shift method is applied.

For each measurement of the DUT 50, the signal generation unit 80 provides to the signal evaluation unit 90 through the link 100 the present settings of the parameters for the center wavelength(s) and the modulation frequency(ies) of the laser signals provided by the two laser sources 10 and 20. As an alternative, the signal generation unit 80 encodes and adds the present settings of the parameters for the center wavelength(s) and the modulation frequency(ies) of the laser signals to the modulation signal for the modulators 30 and 40, thus eliminating the need for the separate connection 100 between signal generation unit 80 and signal evaluation unit 90. A phase difference between the modulation signals of the first and second laser wavelengths can be determined e.g. either from a phase jump which occurs with every change between first and second wavelength, or by providing a synchronized phase reference signal, which can be derived from the first or second modulation frequency by taking advantage of a sample and hold phase-lock-loop (PLL) circuit.

The measurement process may also take place in a pre-defined sequence, with pre-programmed settings for laser wavelengths and modulation frequencies. Start, trigger and stop codes define the run off and the extent of the measurement. With this approach the connection 100 between signal generation 80 and signal evaluation 90 is rendered unnecessary too.

1. A system for determining a characteristic of an optical property of a device under test—DUT—, wherein the optical property is at least one of a group comprising chromatic dispersion and group delay, the system comprising:
a signal evaluation unit adapted for receiving response signals of the DUT on an applied first laser signal at a first center wavelength modulated by a first modulation frequency and an applied second laser signal at a second center wavelength modulated by a second modulation frequency, and for determining the characteristic of the optical property of the DUT based on an analysis of the received response signals in conjunction with the parameter settings for the first center wavelength, the first modulation frequency, the second center wavelength, and the second modulation frequency.

2. The system of claim 1, wherein the signal evaluation unit is adapted for determining phase differences between the response signals for determining the characteristic of the optical property of the DUT.

3. The system of claim 1, wherein the first modulation frequency equals the second modulation frequency.

4. The system of claim 1, further comprising a signal generation unit having:
at least one laser device adapted for providing to the DUT the first laser signal at the first center wavelength modulated by the first modulation frequency, and the second laser signal at the second center wavelength modulated by the second modulation frequency.

5. The system of claim 1, wherein at least one of the first and second laser signals is intensity-modulated.

6. The system of claim 1, wherein the first and second laser signals are applied concurrently or serially.

7. A method for determining a characteristic of an optical property of a device under test—DUT—, wherein the optical property is at least one of a group comprising chromatic dispersion and group delay, the method comprising the steps of:
(a) receiving response signals from the DUT on an applied first laser signal at a first center wavelength modulated by a first modulation frequency and an applied second laser signal at a second center wavelength modulated by a second modulation frequency, and
(b) determining the characteristic of the optical property of the DUT by analyzing the received response signals in conjunction with the parameter settings for the first center wavelength, the first modulation frequency, the second center wavelength, and the second modulation frequency.

8. The method of claim 7, further comprising prior to step a the steps of:
providing to the DUT the first laser signal at the first center wavelength modulated by the first modulation frequency, and
providing to the DUT the second laser signal at the second center wavelength modulated by the second modulation frequency.

9. The method of claim 7, wherein step b comprises a step of determining a phase difference between the response signals.

10. The method of claim 9, wherein the first modulation frequency equals the second modulation frequency.

11. The method according to claim 7, wherein at least one of the first and second laser signals is intensity-modulated.

12. The method according to claim 7, wherein the first and second laser signals are applied concurrently or serially.
